(19) United States
(12) Patent Application Publication
(10) Pub. No.: US 2006/0075454 A1
(43) Pub. Date: Apr. 6, 2006

(54) Method and apparatus for summarizing moving picture of sports game

(75) Inventors: Cheolkon Jung, Suwon-si (KR); Jiyeun Kim, Seoul (KR); Whoiyul Kim, Seoul (KR); Sangkyun Kim, Yongin-si (KR); Euijin Kim, Seoul (KR); Gwanggook Lee, Seoul (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/236,637

(22) Filed: Sep. 28, 2005

(30) Foreign Application Priority Data
Oct. 5, 2004 (KR) 10-2004-0079248

(51) Int. Cl. H04N 7/16; G06F 13/00; G06F 3/00

(52) U.S. Cl. 725/135; 725/40

(57) ABSTRACT

A method and apparatus for summarizing a moving picture of a sports game, such as a basketball game, based on scores. The method includes detecting score information of each shot of a moving picture of a sports game, calculating a degree of importance of each shot using the detected score information of each shot, and summarizing the moving picture using the calculated degree of importance of each shot. In the method, a moving picture of a sports game is summarized using degrees of importance of shots selected based on scores having important information regarding the sports game. Therefore, the reliability of summarization of the moving picture can be enhanced. Further, the amount of data calculation required for summarizing the moving picture can be reduced since the moving picture is summarized using changes in score information that has a small amount of data.

### CROSS-REFERENCE TO RELATED APPLICATION

This application claims the priority of Korean Patent Application No. 10-2004-0079248, filed on Oct. 5, 2004, in the Korean Intellectual Property Office, the disclosure of which is incorporated herein in its entirety by reference.

### BACKGROUND OF THE INVENTION

1. Field of the Invention

The present invention relates to a method and apparatus for summarizing a moving picture, and more particularly, to a method and apparatus for summarizing a moving picture of a sports game, such as a basketball game, based on the score of the game.

2. Description of Related Art

Image reproducing apparatuses, such as personal video recorders (PVRs), reproduce moving pictures stored in storage devices such that users can view the moving pictures on display devices. Image reproducing apparatuses also decode encoded image data and output the decoded image data. With the development of networks, digital storage devices, and image compression and restoration technologies, the use of image reproducing apparatuses storing digital images in storage devices before reproducing the stored digital images has increased greatly.

When a moving picture of a sports game that lasts more than two hours, such as a basketball game, is recorded, a user needs a function for easily and quickly selecting, editing, and reproducing a desired scene of the moving picture, such as a see-saw game scene, a pursuit scene, or an reversal scene. Such a function for enabling a user to easily and quickly grasp the contents of a moving picture is called an image summary.

According to a conventional method of summarizing a moving picture of a sports game, events, such as offenses, swift attacks, or shootings, are detected using information, such as colors, motions, and sounds, extracted from a moving picture of a sports game. Then, the moving picture is summarized based on the detected events. Alternatively, a moving picture may be divided into play shots and non-play shots and a summary moving picture including only the play shots may be generated.

When summarizing a moving picture of a sports game, such as a basketball game by such a conventional method, scenes unimportant to describing the overall flow of the sports game are included in a summary moving picture, which may negatively affect the quality of the summary moving picture. Since a summary moving picture longer than what a user desired is generated, efficiency in summarizing a moving picture of a sports game may be undermined.

### BRIEF SUMMARY

An aspect of the present invention provides a method and apparatus for summarizing a moving picture of a sports game using score information extracted from the moving picture of the sports game.

According to an aspect of the present invention, there is provided a method of summarizing a moving picture of a sports game. The method includes detecting score information of each shot of the moving picture; calculating a degree of importance of each shot using the detected score information of each shot; and summarizing the moving picture using the calculated degree of importance of each shot.

The detecting of the score information may include dividing the moving picture into a plurality of shots; and detecting score information of images included in each shot.

In the detecting of the score information of the images, the score information of some of the images included in each shot may be detected. Alternatively, the detecting of the score information of the images may include extracting data of score areas of the images included in each shot; and detecting the score information of the images using the extracted data of the score areas.

Also, the detecting of the score information of the images may include extracting data of score areas of the images included in each shot; and detecting the score information of the images using the extracted data of the score areas.

In the detecting of the score information of the images, scores included in the images may be recognized from the extracted data of the score areas using an artificial neural network. The calculating of the degree of importance of each shot may include detecting an event that occurred in each shot using the detected score information of each shot; and calculating the degree of importance of each shot based on the detected event in each shot. The detected event may include at least one of a 3-point shoot event, a one-sided game event, a see-saw game event, a pursuit event, and a reversal event. A one-sided game event means that team leads a game one-sidedly with continuous scoring. A see-saw game event means that lead of the game changes frequently in a short time periods. Pursuit event means that the losing team scores continuously hence the score difference reduces quickly in a short time period. Reversal event means that the winning team is altered.

The degree of importance of each shot may be calculated using a weight for the detected event from each shot. A user may set the weight for each event.

The summarizing of the moving picture may include selecting important shots of the moving picture using the calculated degree of importance of each shot; and summarizing the moving picture using the selected important shots.

The important shots may be selected such that a total period of reproduction time of the important shots is shorter than a period of summary time predetermined by the user.

The method may further include dividing the shots of the moving picture into play shots and non-play shots; and eliminating the non-play shots from a summary of the moving picture.

According to another aspect of the present invention, there is provided a method of summarizing a moving picture of a sports game. The method includes detecting a score area of the moving picture; dividing the moving picture into a plurality of shots; detecting score information of each shot using data of the detected score area of images included in each shot; calculating a degree of importance of each shot using the detected score information of each shot; and summarizing the moving picture using the calculated degree of importance of each shot.

The detecting of the score area may include detecting a scoreboard area from the images included in the moving picture of the sports game; and detecting the score area having the score information from the detected scoreboard area.

The detecting of the score area from the scoreboard area may include extracting edge information of images in a predetermined time section out of the images included in the moving picture; and detecting the scoreboard area of the moving picture using a change in the extracted edge information over time.

The detecting of the score area from the scoreboard area may include extracting image data of the detected scoreboard area of the images in the predetermined time section; and detecting the score area of the moving picture using a change in the extracted image data.

The detecting of the score area using a change in the image data may include detecting an area where the extracted image data changes by comparing the extracted image data; and detecting an area having an irregular cycle of change from the area where the extracted image data changes.

The detecting of the score area using a change in the image data may include detecting the area where the extracted image data changes by comparing the extracted image data; recognizing a number included in the detected area where the extracted image data changes from each of the images in the predetermined time section using data of the area where the extracted image data changes; and detecting an area where, the recognized number increases over time from the detected area where the extracted image data changes.

According to another aspect of the present invention, there is provided an apparatus for summarizing a moving picture of a sports game. The apparatus includes a score detecting unit receiving the moving picture and detecting score information of each shot of the moving picture; an importance calculating unit calculating and outputting a degree of importance of each shot using the detected score information of each shot; and a summarizing unit selecting important shots of the moving picture based on the calculated degree of importance of each shot and summarizing the moving picture using the selected important shots.

The score detecting unit may include a shot divider dividing the moving picture into sections of the same scenes and outputting information regarding the division of the moving picture; and a score-per-shot detector receiving the information regarding the division of the moving picture, detecting score information of images included in each shot, and outputting the score information of each shot. The score information of each shot may denote the score information of some of the images included in each shot.

The score-per-shot detector may include a score data extractor receiving the information regarding the division of the moving picture and extracting data of a score area of the images included in each shot of the moving picture; and a score recognizer recognizing the score information of the images using the extracted data of the score area.

The score recognizer may recognize scores included in the images from the extracted data of the score area using an artificial neural network.

The importance calculating unit may include an event detector detecting an event that occurred in each shot using the detected score information of each shot; and a calculator calculating the degree of importance of each shot based on the detected event in each shot. The calculator may calculate the degree of importance of each shot using a weight set for the detected event from each shot.

A user may set the weight for each event. The important shots may be selected such that a total period of reproduction time of the important shots is shorter than a period of summary time predetermined by the user.

The apparatus may further include an area detecting unit receiving the moving image and detecting the score area having score information of the images included in the moving picture.

The area detecting unit may include a scoreboard area detector detecting a scoreboard area from the images included in the moving picture of the sports game and outputting information regarding the scoreboard area; and a score area detector receiving the information regarding the scoreboard area and detecting the score area having the score information from the detected scoreboard area of the images included in the moving picture.

The scoreboard area detector may include an edge extractor extracting edge information of images in a predetermined time section out of the images included in the moving picture; and an edge change detector receiving the extracted edge information of the images and detecting the scoreboard area of the moving picture using a change in the extracted edge information over time.

The score are detector may include a scoreboard data extractor receiving the information regarding the scoreboard area and extracting image data of the scoreboard area of the images in the predetermined time section out of the images included in the moving picture; and a change detector receiving the extracted image data of the scoreboard area and detecting the score area of the moving picture using a change in the extracted image data.

The change detector may include a change area detector comparing the extracted image data of the scoreboard area and detecting an area where the image data changes for a predetermined period of time; and an irregular area detector detecting an area having an irregular cycle of change from the detected area where the image data changes for the predetermined period of time.

The change detector may include the change area detector comparing the extracted image data of the scoreboard area and detecting the area where the image data changes for the predetermined period of time; a number recognizer recognizing a number included in the detected area where the extracted image data changes for the predetermined period of time using data of the detected area where the extracted image data changes for the predetermined period of time; and an incremental area detector detecting an area where the recognized number increases over time from the detected area where the extracted image data changes for the predetermined period of time.

According to other aspects of the present invention, there are provided computer-readable storage media encoded with processing instructions for causing a processor to perform the aforementioned methods.

Additional and/or other aspects and advantages of the present invention will be set forth in part in the description which follows and, in part, will be obvious from the description, or may be learned by practice of the invention.

### BRIEF DESCRIPTION OF THE DRAWINGS

The above and/or other aspects and advantages of the present invention will become apparent and more readily appreciated from the following detailed description, taken in conjunction with the accompanying drawings of which:

FIG. 1 is a block diagram of an apparatus for summarizing a moving picture of a sports game according to an embodiment of the present invention;

FIG. 2 is a detailed block diagram of an area detecting unit illustrated in FIG. 1;

FIG. 3(a) through (c) are images for illustrating a method of detecting a score area from a moving picture of a sports game according to an embodiment of the present invention;

FIG. 4 illustrates edge information detected from a text area of a moving picture of a sports game according to an embodiment of the present invention;

FIG. 5(a) through (d) are images illustrating a method of detecting a scoreboard area from a moving picture of a sports game according to an embodiment of the present invention;

FIG. 6(a) through (d) are views illustrating a method of detecting text areas from a detected scoreboard area according to an embodiment of the present invention;

FIG. 7 is a graph illustrating a method of dividing the detected scoreboard area into a white area and a black area according to an embodiment of the present invention;

FIG. 8(a) through (c) are screens illustrating a method of detecting a score area from detected text areas according to an embodiment of the present invention;

FIG. 9 is a block diagram of a score detecting unit according to an embodiment of the present invention;

FIG. 10(a) through (d) are images illustrating a method of dividing a moving picture of a sports game into play shots and non-play shots according to an embodiment of the present invention;

FIG. 11 illustrates fonts learned by an artificial neural network that recognizes scores according to an embodiment of the present invention;

FIG. 12 is a block diagram of an importance calculating unit illustrated in FIG. 1;

FIG. 13 is a flowchart illustrating a method of summarizing a moving picture of a sports game according to an embodiment of the present invention;

FIG. 14 is a detailed flowchart illustrating the operation of detecting a score area of the moving picture of the sports game illustrated in FIG. 13 according to an embodiment of the present invention;

FIG. 15 is a detailed flowchart illustrating the operation of detecting a scoreboard area of the moving picture of the sports game illustrated in FIG. 14 according to an embodiment of the present invention;

FIG. 16 is a flowchart illustrating a method of detecting a score area from the scoreboard area illustrated in FIG., 14 according to an embodiment of the present invention;

FIG. 17 is a detailed flowchart illustrating the operation of detecting score information of each shot illustrated in FIG. 13 according to an embodiment of the present invention;

FIG. 18 is a detailed flowchart illustrating the operation of calculating a degree of importance of each shot illustrated in FIG. 13 according to an embodiment of the present invention.

### DETAILED DESCRIPTION OF EMBODIMENTS

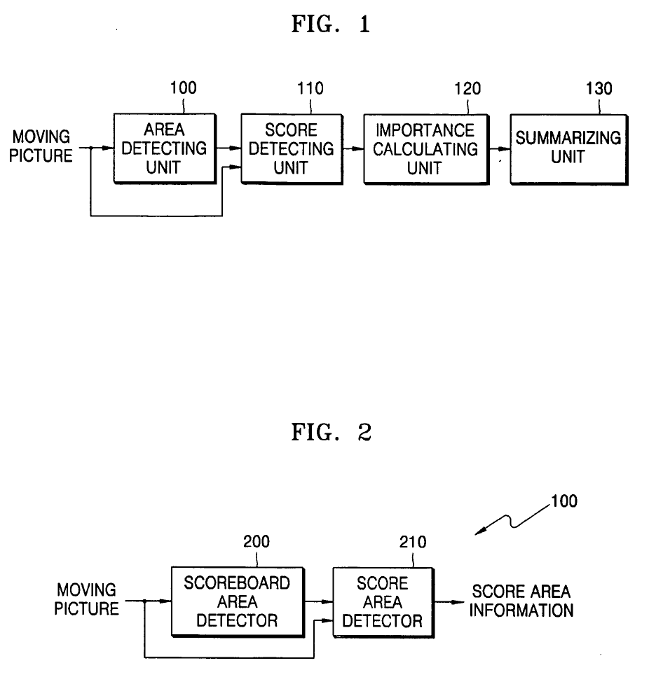

FIG. 1 is a block diagram of an apparatus for summarizing a moving picture of a sports game according to an embodiment of the present invention. The apparatus includes an area detecting unit 100, a score detecting unit 110, an importance calculating unit 120, and a summarizing unit 130. The operation of the apparatus will now be described in association with a flowchart illustrating a method of summarizing a moving picture of a sports game illustrated in FIG. 13.

The area detecting unit 100 receives a moving picture of a sports game to be summarized, detects a score area where the score of the game is recorded in the moving picture, and outputs a signal having information regarding the detected score area (operation 1300). The signal output from the area detecting unit 100 may have information regarding a pixel position in the lower left of the detected score area that is square and a pixel position in the upper right of the detected score area.

The score detecting unit 110 receives the moving picture, and the information regarding the detected score area from the area detecting unit 100, divides the moving picture into a plurality of shots which are sections of the same scenes (operation 1310), and detects the score of the game in the score area from images included in each of the shots (operation 1320). Meanwhile, in the dividing of the moving picture into the shots, a cut where a chromatic difference between two consecutive images in the moving picture changes abruptly may be detected and, based on the detected cut, the moving picture may be divided. In the detecting of scores per shot, scores may be detected in some of the images included in each shot, for example, one out of every ten images.

The importance calculating unit 120 receives score information of each shot and calculates a degree of importance of each shot based on the score information (operation 1330).

The summarizing unit 130 receives the calculated degree of importance of each shot from the importance calculating unit 120, selects important shots based on the calculated degree of importance of each shot (operation 1340), and summarizes the moving picture using the selected shots (operation 1350). In operation 1340, when a user inputs a desired length of the summarized moving picture, the important shots may be selected such that a total period of reproduction time of the summarized moving picture does not exceed the desired length input by the user.

For example, when a user desires to summarize a moving picture of a basketball game, which includes 200 shots, into a minute long moving picture, if the total period of reproduction time of 20 most important shots out of the 200 shots is 58 seconds and the total period of reproduction time of 21 most important shots out of the 200 shots is 1 minute and 5 seconds, the 20 most important shots are selected from the 200 shots. The selected shots are combined according to their sequence and generated as a summary moving picture.

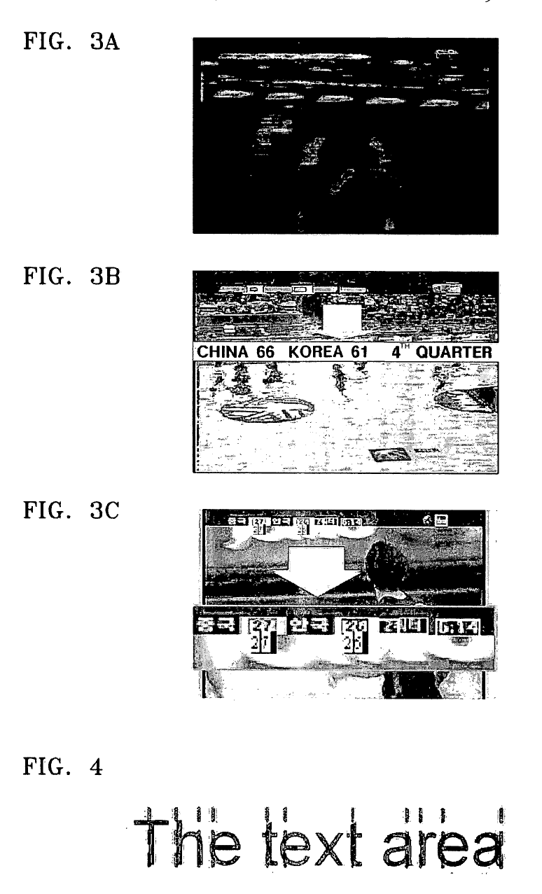

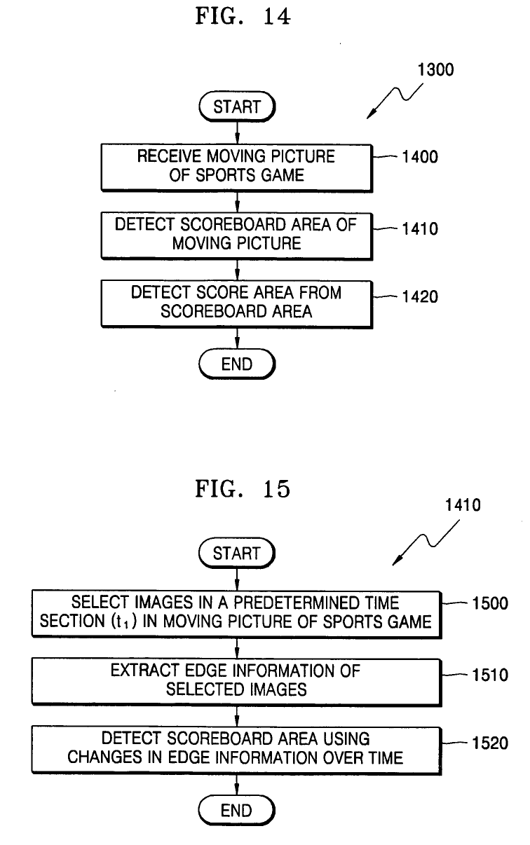

FIG. 2 is a block diagram of the area detecting unit 100 illustrated in FIG. 1. The area detecting unit 100 includes a scoreboard area detector 200 and a score area detector 210. The operation of the area detecting unit 100 will now be described in association with a flowchart illustrated in FIG. 14.

The scoreboard area detector 200 receives a moving picture of a sports game to be summarized (operation 1400) and detects a scoreboard area of the moving picture, which has text information such as scores, a total match time, and teams (operation 1410). The score area detector 210 receives the moving picture, and position information of the scoreboard area from the scoreboard area detector 200, detects a score area having score information from the scoreboard area of the moving picture, and outputs a signal having position information of the score area (operation 1420).

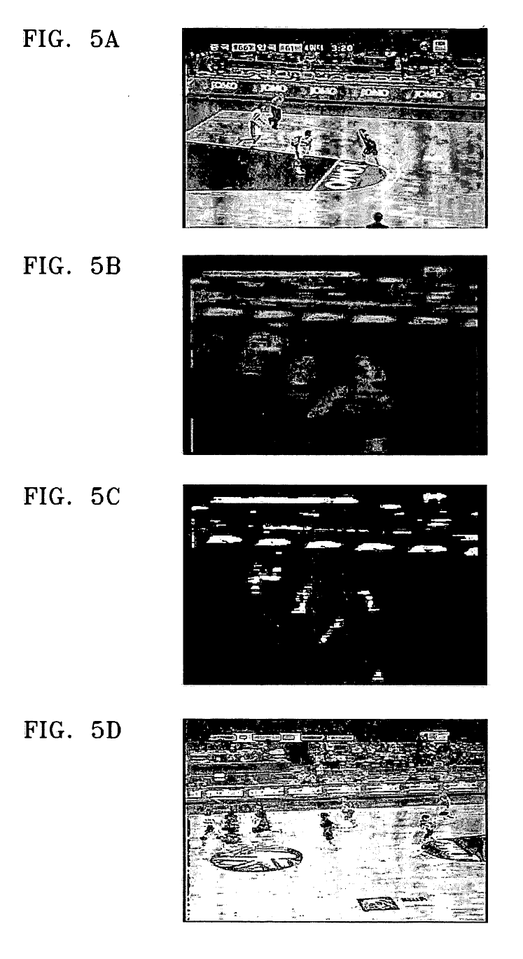

FIG. 3(a) through (b) are images illustrating a method of detecting a score area from a moving picture of a sports game according to an embodiment of the present invention. FIG. 3(a) is an image obtained as a result of extracting vertical edge information from the moving picture. The vertical edge information is calculated by

$$A ( x , y ) = {\sum }_{i = - t}^{t} \frac{\partial I}{\partial x} ( x + i , y ) \qquad ( 1 )$$

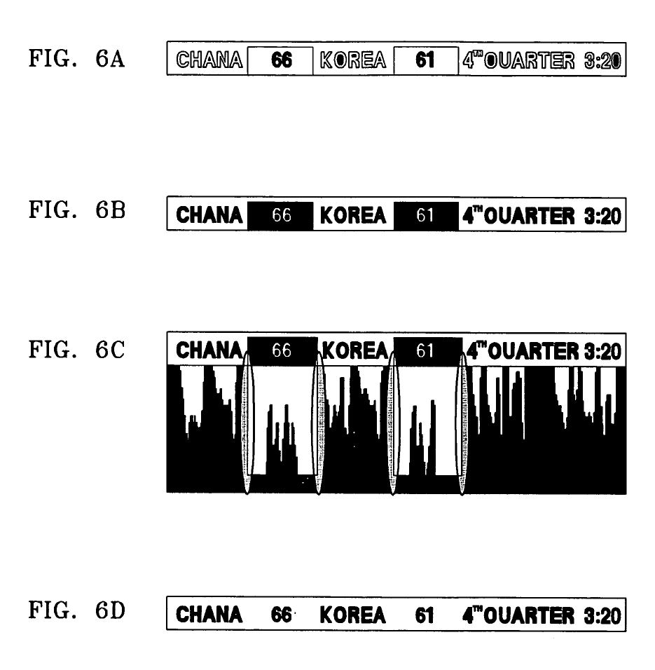

Equation 1 is used to calculate edge information of an area of the moving picture, the area having a horizontal length of t from position (x, y) to the right and left, respectively. Here, I (x+i, y) denotes a luminance value of position (x+1, y) in the moving picture. FIG. 4 illustrates edge information detected from a text area of the moving picture. It can be seen that the text area characteristically has a vertical edge of a high value.

FIG. 3(b) is an image obtained as a result of detecting a scoreboard area using the edge information of the moving picture calculated using Equation 1. FIG. 3(c) is an image obtained as a result of detecting a score area from the detected scoreboard area.

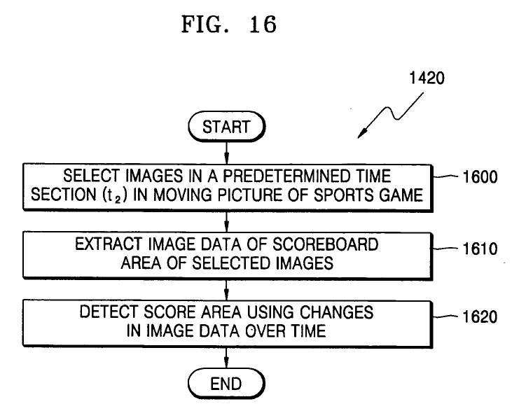

FIG. 5(a) through (d) are images illustrating a method of detecting a scoreboard area from a moving picture of a sports game according to an embodiment of the present invention. The method will now be described in association with a flowchart illustrated in FIG. 15. FIG. 5(a) is an image showing an image included in the moving picture. FIG. 5(b) is an image obtained as a result of extracting vertical edge information from the image by calculating the vertical edge information using Equation 1. FIG. 5(c) is an image showing the image divided into an area having an edge value within the range of top 10 percent of edge values and the other area. FIG. 5(d) is an image displaying a detected scoreboard.

A section having a reproduction time period of t1 is randomly selected from a moving picture of a sports game to be summarized (operation 1500). Edge information as illustrated in FIG. 5(b) is extracted from each of images included in the selected section using Equation 1, and each of the images is divided into an area having an edge value within the range of top 10 percent of edge values and the other area (operation 1510). The area having the edge value within the range of top 10 percent of edge values for more than a predetermined period of time is detected as the scoreboard area (operation 1520).

FIG. 16 is a flowchart illustrating a method of detecting a score area from a scoreboard area. A section having a reproduction time period of t2 is randomly selected from a moving picture of a sports game to be summarized (operation 1600). Image data of the scoreboard area is extracted from images included in the selected section (operation 1610). Using changes in the extracted image data of the scoreboard area over time, the score area is detected from the scoreboard area (operation 1620).

In the detecting of the score area using the changes in the image data over time, the score area is detected based on the characteristic that, unlike team names, scores change over time but do not have regular cycles of change, unlike a total match time. Specifically, the text area is detected from the image data of the scoreboard area. Of the text area, an area having an irregular cycle of change over time is detected as the score area. Alternatively, the detected text area may be recognized as numbers by an artificial neural network and, of the numbers, an area having an irregular cycle of change may be detected as the score area.

FIG. 6(a) through (d) are views for illustrating a method of detecting text areas from a detected scoreboard area according to an embodiment of the present invention. FIG. 6(a) illustrates the scoreboard area of a moving picture of a sports game, the scoreboard area converted into a gray-level image. FIG. 6(b) illustrates the scoreboard area divided into a text area and a background area.

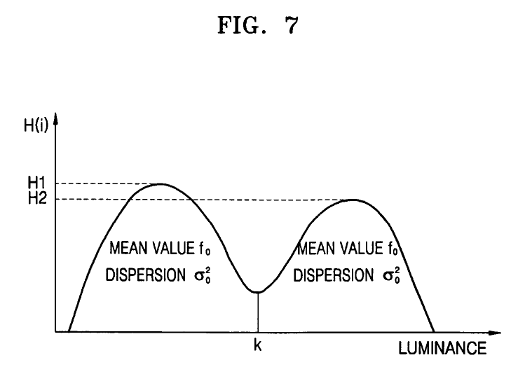

A method of dividing the scoreboard area into the text area and the background area will now be described with reference to a graph illustrated in FIG. 7. Pixel values having luminance values smaller than k are selected from pixel values in the scoreboard area. Then, a mean value (f₀) and dispersion (σ²₀) of the luminance values of the pixel values are calculated. Also, pixel values having luminance values larger than k are selected from the pixel values in the scoreboard area. Then, a mean value (f₁) and dispersion value (σ²₁) of the luminance values of the pixel values are calculated. A value of k when the calculated dispersion (σ²₀,σ²₁) is largest is obtained. The scoreboard area is divided into an area having a luminance value smaller than the value of k and an area having a luminance value greater than the value of k. FIG. 6(b) illustrates a result of dividing the scoreboard area into the text area and the background area using the method described above and inversing the color of the scoreboard area.

FIG. 6(c) is a view for illustrating a method of inversing the text area into black when characters in the scoreboard area are not presented in the same color as illustrated in FIG. 6(b). A vertical projection of the scoreboard area may lead to the extraction of data as illustrated in FIG. 6(c). The result of the vertical projection of the scoreboard shows a proportion of white in a vertical direction. As illustrated in FIG. 6(c), at both edges of a square around a score, the vertical projection changes sharply. Two points at which the vertical projection changes sharply are obtained and the color of an area between the two points is inversed. Then, the whole text area in the scoreboard area can be presented in black as illustrated in FIG. 6(d).

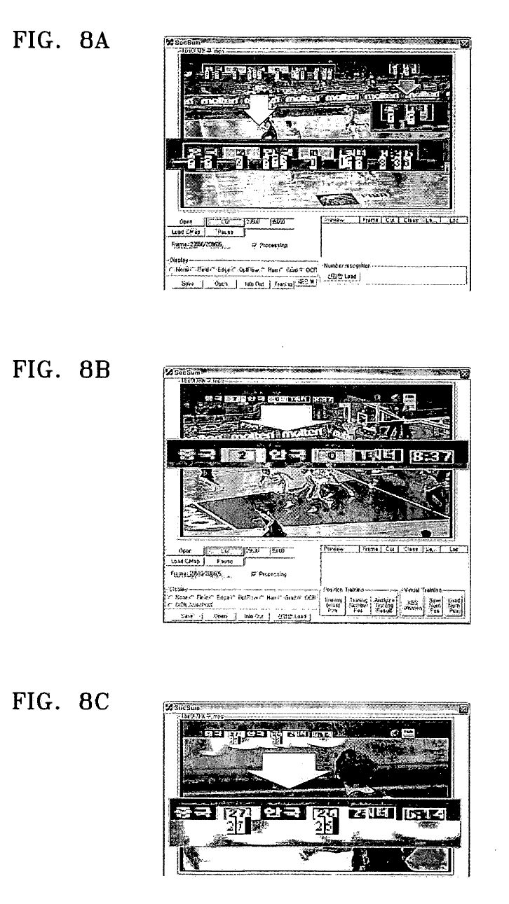

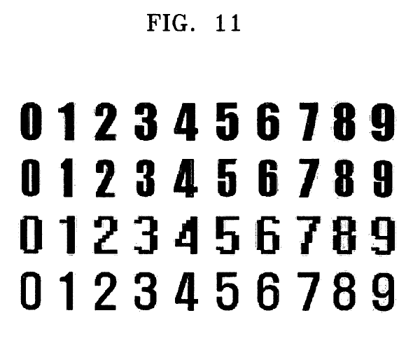

FIG. 8(a) through (d) are screens illustrating a method of detecting a score area from detected text areas according to an embodiment of the present invention. FIG. 8 (a) is a screen illustrating the text areas recognized as numbers by an artificial neural network. The artificial neural network used for number recognition may learn number fonts as illustrated in FIG. 11.

FIG. 8(b) is a screen obtained as a result of detecting portions of the text areas, which are recognized as numbers. FIG. 8(c) illustrates a screen obtained as a result of detecting score areas having irregular cycles in the detected number portions of the text areas. As illustrated in FIG. 8(b), numbers included in the scoreboard area include scores, time, and quarters. Except for scores, time and quarters have regular cycles of change over time. Thus, changes of numbers, which have been detected for a predetermined period of time using the method described above, are stored in a storage medium and number areas without regular cycles of change may be detected as the score area. Alternatively, if only the points of both teams and a match time are composed of numbers in the scoreboard area, an area where the recognized numbers increase over time may be detected as the score area.

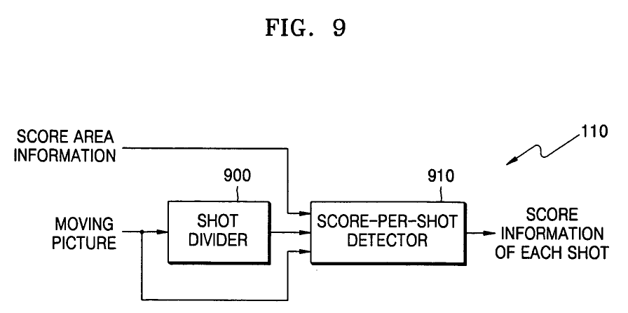

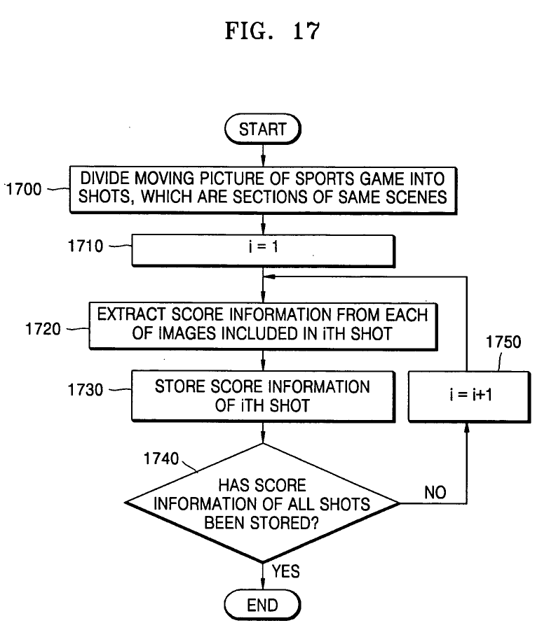

FIG. 9 is a block diagram of a score detecting unit 110 according to an embodiment of the present invention. The score detecting unit 110 includes a shot divider 900 and a score-per-shot detector 910. The operation of the score detecting unit 110 will now be described in association with a flowchart illustrated in FIG. 17.

The shot divider 900 divides a moving picture of a sports game to be summarized into shots, which is a section for the same scenes (operation 1700). The score-per-shot detector 910 receives the moving picture and information regarding a score area, and information regarding the division of the moving picture into the shots from the shot divider 900, and extracts scores in the score areas of images included in a first shot (operations 1710 and 1720). The scores may be extracted using an artificial neural network, which has learned to recognize numbers. The artificial neural network used for number recognition may learn number fonts as illustrated in FIG. 11, which are commonly used as scores in a moving picture of a sports game.

The score-per-shot detector 910 stores score information of the first shot (operation 1730), determines whether score information of all shots of the moving picture is stored (operation 1740), and repeats operations 1720 and 1730 until the score information of all shots is stored.

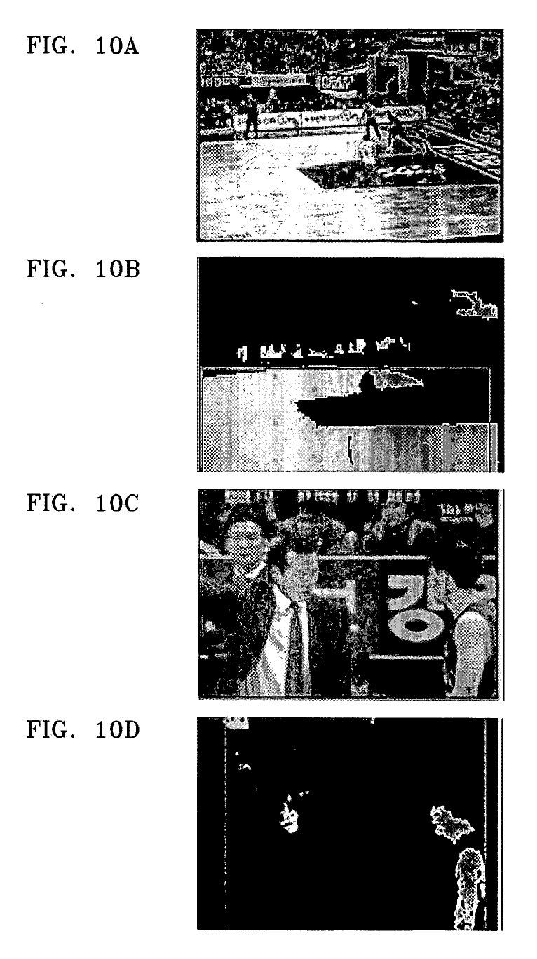

FIG. 10(a) through (d) are images illustrating a method of dividing a moving picture of a sports game into play shots and non-play shots according to an embodiment of the present invention. FIG. 10(a) is an image showing basketball players playing in a basketball game. FIG. 10(b) is an image obtained as a result of detecting an area having the color of a court, where the basketball game is being played, from the image of FIG. 10(a). The color of the court may be directly input by a user or a color commonly used for a court in each sports game may be preset and stored.

FIG. 10(c) is an image showing the basketball players without playing in the basketball game. FIG. 10(d) is an image obtained as a result of detecting an area having the color of a court, where the basketball game is not being played, from the image of FIG. 10(c).

When comparing FIG. 10(b) with FIG. 10(d), it can be seen that the proportion of the area having the color of the court is much higher in the image corresponding to the play shot in which the basketball players are playing basketball than in the image corresponding to the non-play shot in which the basketball players are not playing basketball. Therefore, in the moving picture, a section for consecutive images having a higher proportion of the area having the color of court than a predetermined proportion may be determined as a play shot. Only in play shots, scores may be detected and degrees of importance may be calculated according to the detected scores. Based on the calculated degrees of importance, shots to be used for summarizing the moving picture may be selected.

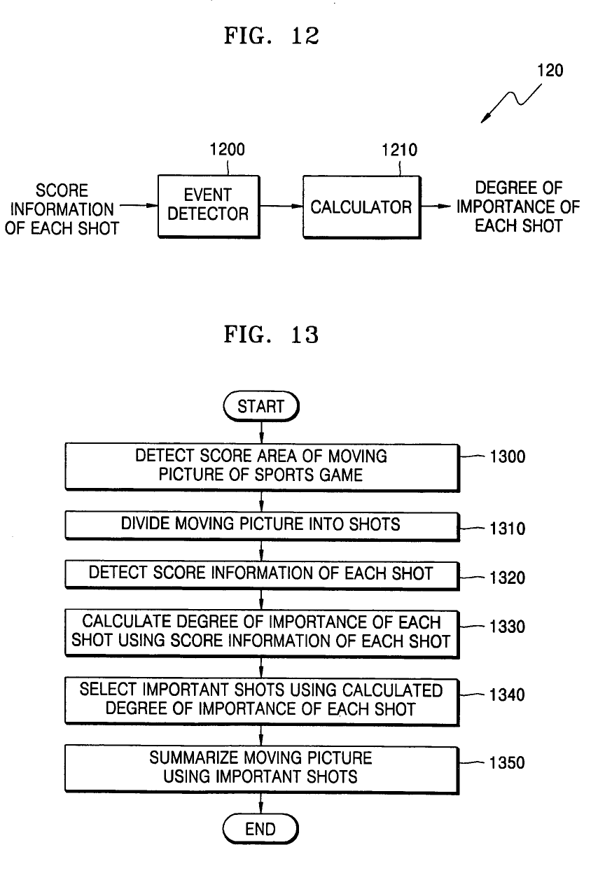

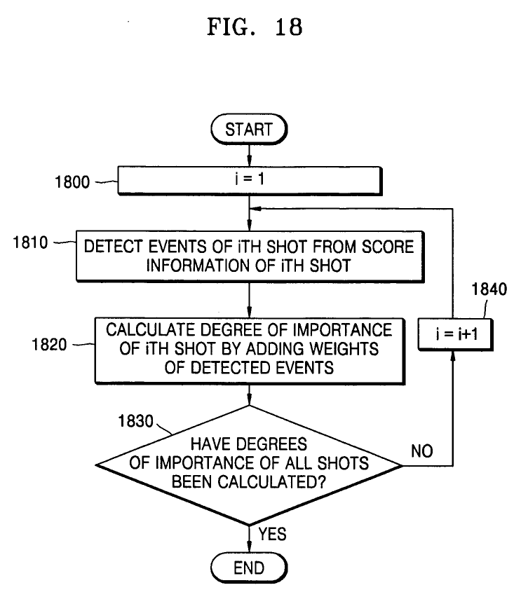

FIG. 12 is a block diagram of the importance calculating unit 120 illustrated in FIG. 1. The importance calculating unit 120 includes an event detector 1200 and a calculator 1210. The operation of the importance calculating unit 120 will now be described in association with a flowchart of FIG. 18.

The event detector 1200 receives score information of each shot of a moving picture of a sports game from the score detector 110 and detects events that occurred in a first shot (operations 1800 and 1810). Events may be preset according to characteristics of each sports game. For example, a see-saw game, one-sided leading, pursuit, and reversal may be set as events in all sports games. In a basketball game, 3-point shooting and free throwing may be set as events. In addition, the user may define desired events.

A method of detecting events using, for example, score information, in a basketball game will now be described in detail. A one-sided leading event refers to a situation where a winning team is defeating a losing team by a huge margin. If the winning team scores more than three times in a row, the event detector 1200 detects the occurrence of the one-sided leading event.

A see-saw game event refers to a situation where a winning team changes continuously. If a winning team changes more than twice within two minutes, the event detector 1200 detects the occurrence of the see-saw game event.

A reversal event refers to a situation where a winning team is overtaken by a losing team. A pursuit event refers to a situation where the score of the losing team becomes closer to the score of the wining team. If the difference between the scores of both teams is reduced from 6 points to 2 points, the event detector 1200 detects the occurrence of the pursuit event.

If the difference between two scores obtained by a team, which is extracted from two sequential images, is 3 points, the event detector 1200 detects the occurrence of the 3-point shoot event. If the difference between two scores obtained by the team, which is extracted from two sequential images, is one point, the event detector 1200 detects the occurrence of the free-throw event.

The calculator 1210 receives information regarding events that occurred in the first shot from the event detector 1200 and calculates a degree of importance of each shot according to a weight for each event (operation 1820). For example, if the 3-point shoot event and the see-saw game event are detected in the first shot and the weight for the 3-point shoot event is set to 2 and the weight for the see-saw game event is set to 10, the degree of importance of the first shot is 12.

The weight for each event may be set in consideration of the importance of each event. Alternatively, the user may set the weight for each event or may reset weights that have already been set. For example, if the user desires to view scenes of 3-point shooting in the moving picture of the basketball game, the weights for all events except for the 3-point shoot event may be set to zero and a weight may be given only to the 3-point shoot event.

The calculator 1210 determines whether the degrees of importance of all shots in the moving picture have been calculated (operation 1830) and repeats operations 1810 and 1820 until the degrees of importance of all shots are calculated.

In a method and apparatus for summarizing a moving picture of a sports game according to the above-described embodiments of the present invention, a moving picture of a sports game is summarized using degrees of importance of shots selected based on scores. Therefore, the reliability of summarization of the moving picture can be enhanced. Further, the amount of data calculation required for summarizing the moving picture can be reduced since the moving picture is summarized using changes in score information that has a small amount of data.

Embodiments of the present invention can also be implemented as computer-readable code on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, and carrier waves (such as data transmission through the Internet).

Such a computer-readable recording medium can also be distributed over network-coupled computer systems so that the computer-readable code is stored and executed in a distributed fashion. Also, functional programs, codes, and code segments for accomplishing the present invention can be easily construed by programmers skilled in the art to which the present invention pertains.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A method of summarizing a moving picture of a sports game, the method comprising:
detecting score information of each shot of the moving picture;
calculating a degree of importance of each shot using the detected score information of each shot; and
summarizing the moving picture using the calculated degree of importance of each shot.

2. The method of claim 1, wherein the detecting of the score information comprises:
dividing the moving picture into a plurality of shots; and
detecting score information of images included in each shot.

3. The method of claim 2, wherein, in the detecting of the score information of the images, the score information of some of the images included in each shot is detected.

4. The method of claim 2, wherein the detecting of the score information of the images comprises:
extracting data of score areas of the images included in each shot; and
detecting the score information of the images using the extracted data of the score areas.

5. The method of claim 4, wherein, in the detecting of the score information of the images, scores included in the images are recognized from the extracted data of the score areas using an artificial neural network.

6. The method of claim 1, wherein the calculating of the degree of importance of each shot comprises:
detecting an event that occurred in each shot using the detected score information of each shot; and
calculating the degree of importance of each shot based on the detected event in each shot.

7. The method of claim 6, wherein the detected event is at least one of a 3-point shoot event, a one-sided game event, a see-saw game event, a pursuit event, and an reversal event.

8. The method of claim 6, wherein the degree of importance of each shot is calculated using a weight for the detected event from each shot.

9. The method of claim 8, wherein a user sets the weight for each event.

10. The method of claim 1, wherein the summarizing of the moving picture comprises:
selecting important shots of the moving picture using the calculated degree of importance of each shot; and
summarizing the moving picture using the selected important shots.

11. The method of claim 10, wherein the important shots are selected such that a total period of reproduction time of the important shots is shorter than a period of summary time predetermined by the user.

12. The method of claim 11, further comprising:
dividing the shots of the moving picture into play shots and non-play shots; and
eliminating the non-play shots from a summary of the moving picture.

13. A method of summarizing a moving picture of a sports game, the method comprising:
detecting a score area of the moving picture;
dividing the moving picture into a plurality of shots;
detecting score information of each shot using data of the detected score area of images included in each shot;
calculating a degree of importance of each shot using the detected score information of each shot; and
summarizing the moving picture using the calculated degree of importance of each shot.

14. The method of claim 13, wherein the detecting of the score area comprises:
detecting a scoreboard area from the images included in the moving picture of the sports game; and
detecting the score area having the score information from the detected scoreboard area.

15. The method of claim 14, wherein the detecting of the scoreboard area comprises:
extracting edge information of images in a predetermined time section out of the images included in the moving picture; and
detecting the scoreboard area of the moving picture using a change in the extracted edge information over time.

16. The method of claim 14, wherein the detecting of the score area from the scoreboard area comprises:
extracting image data of the detected scoreboard area of the images in the predetermined time section; and
detecting the score area of the moving picture using a change in the extracted image data.

17. The method of claim 16, wherein the detecting of the score area using a change in the image data comprises:
detecting an area where the extracted image data changes by comparing the extracted image data; and
detecting an area having an irregular cycle of change from the area where the extracted image data changes.

18. The method of claim 16, wherein the detecting of the score area using a change in the image data comprises:
detecting the area where the extracted image data changes by comparing the extracted image data;
recognizing a number included in the detected area where the extracted image data changes from each of the images in the predetermined time section using data of the area where the extracted image data changes; and
detecting an area where the recognized number increases over time from the detected area where the extracted image data changes.

19. An apparatus for summarizing a moving picture of a sports game, the apparatus comprising:
a score detecting unit receiving the moving picture and detecting score information of each shot of the moving picture;
an importance calculating unit calculating and outputting a degree of importance of each shot using the detected score information of each shot; and
a summarizing unit selecting important shots of the moving picture based on the calculated degree of importance of each shot and summarizing the moving picture using the selected important shots.

20. The apparatus of claim 19, wherein the score detecting unit comprises:
a shot divider dividing the moving picture into sections of the same scenes and outputting information regarding the division of the moving picture; and
a score-per-shot detector receiving the information regarding the division of the moving picture, detecting score information of images included in each shot, and outputting the score information of each shot.

21. The apparatus of claim 20, wherein the score information of each shot denotes the score information of some of the images included in each shot.

22. The apparatus of claim 20, wherein the score-per-shot detector comprises:
a score data extractor receiving the information regarding the division of the moving picture and extracting data of a score area of the images included in each shot of the moving picture; and
a score recognizer recognizing the score information of the images using the extracted data of the score area.

23. The apparatus of claim 22, wherein the score recognizer recognizes scores included in the images from the extracted data of the score area using an artificial neural network.

24. The apparatus of claim 19, wherein the importance calculating unit comprises:
an event detector detecting an event that occurred in each shot using the detected score information of each shot; and
a calculator calculating the degree of importance of each shot based on the detected event in each shot.

25. The apparatus of claim 24, wherein the calculator calculates the degree of importance of each shot using a weight set for the detected event from each shot.

26. The apparatus of claim 25, wherein a user sets the weight for each event.

27. The apparatus of claim 19, wherein the important shots are selected such that a total period of reproduction time of the important shots is shorter than a period of summary time predetermined by the user.

28. The apparatus of claim 19, further comprising an area detecting unit receiving the moving picture and detecting the score area having score information of the images included in the moving picture.

29. The apparatus of claim 28, wherein the area detecting unit comprises:
a scoreboard area detector detecting a scoreboard area from the images included in the moving picture of the sports game and outputting information regarding the scoreboard area; and
a score area detector receiving the information regarding the scoreboard area and detecting the score area having the score information from the detected scoreboard area of the images included in the moving picture.

30. The apparatus of claim 29, wherein the scoreboard area detector comprises:
an edge extractor extracting edge information of images in a predetermined time section out of the images included in the moving picture; and
an edge change detector receiving the extracted edge information of the images and detecting the scoreboard area of the moving picture using a change in the extracted edge information over time.

31. The apparatus of claim 29, wherein the score area detector comprises:
a scoreboard data extractor receiving the information regarding the scoreboard area and extracting image data of the scoreboard area of the images in the predetermined time section out of the images included in the moving picture; and
a change detector receiving the extracted image data of the scoreboard area and detecting the score area of the moving picture using a change in the extracted image data.

32. The apparatus of claim 31, wherein the change detector comprises:
a change area detector comparing the extracted image data of the scoreboard area and detecting an area where the image data changes for a predetermined period of time; and
an irregular area detector detecting an area having an irregular cycle of change from the detected area where the image data changes for the predetermined period of time.

33. The apparatus of claim 31, wherein the change detector comprises:
a change area detector comparing the extracted image data of the scoreboard area and detecting the area where the image data changes for the predetermined period of time;
a number recognizer recognizing a number included in the detected area where the extracted image data changes for the predetermined period of time using data of the detected area where the extracted image data changes for the predetermined period of time; and
an incremental area detector detecting an area where the recognized number increases over time from the detected area where the extracted image data changes for the predetermined period of time.

34. A computer-readable storage medium encoded with processing instructions for causing a processor to perform a method of summarizing a moving picture of a sports game, the method comprising:
detecting score information of each shot of the moving picture;
calculating a degree of importance of each shot using the detected score information of each shot; and
summarizing the moving picture using the calculated degree of importance of each shot.

35. A computer-readable storage medium encoded with processing instructions for causing a processor to perform a method of summarizing a moving picture of a sports game, the method comprising:
detecting a score area of the moving picture;
dividing the moving picture into a plurality of shots;
detecting score information of each shot using data of the detected score area of images included in each shot;
calculating a degree of importance of each shot using the detected score information of each shot; and
summarizing the moving picture using the calculated degree of importance of each shot.
